(19) United States
(12) Patent Application Publication
(10) Pub. No.: US 2014/0279588 A1
(43) Pub. Date: Sep. 18, 2014

(54) LEGAL MANDATE SYSTEM AND METHOD

(71) Applicant: EXTERRO, INC., Tigard, OR (US)

(72) Inventors: James FitzGerald, Beaverton, OR (US); Ganesh Shankar, Beaverton, OR (US); Ajith Samuel, Beaverton, OR (US); Ganeshkumar Balusamy, Coimbatore (IN); Balamanikandan Gopalakrishnan, Coimbatore (IN); Arun Sivakumar, Coimbatore (IN)

(73) Assignee: EXTERRO, INC., Tigard, OR (US)

(21) Appl. No.: 14/211,641

(22) Filed: Mar. 14, 2014

Related U.S. Application Data
(60) Provisional application No. 61/800,555, filed on Mar. 15, 2013.

(51) Int. Cl. G06Q 50/18; G06Q 10/00

(52) U.S. Cl. CPC G06Q 50/18; G06Q 10/00
USPC 705/311

(57) ABSTRACT

Various systems and methods for managing legal mandates are provided. In one example, a management system comprises at least one processor and memory in communication with the at least one processor, the memory storing instructions executable by the at least one processor to receive a legal mandate, in response to receiving the legal mandate, generate a review board comprising a list of one or more individual reviewers, send the legal mandate to the review board, and receive one or more comments from the one or more individual reviewers with respect to the legal mandate. The legal mandate may be a legal hold, and the instructions may be further executable to issue the legal mandate to one or more custodian representatives implicated by the legal mandate after receiving the one or more comments.

### CROSS REFERENCE TO RELATED APPLICATIONS

This application claims priority to U.S. Provisional Patent Application No. 61/800,555, entitled “LEGAL MANDATE SYSTEM AND METHOD,” filed Mar. 15, 2013, the entire contents of which are hereby incorporated herein by reference for all purposes.

### BACKGROUND AND SUMMARY

The present application relates to the process of issuing litigation mandate notices to custodian representatives before actively involving a custodian in a legal hold for data preservation. Embodiments of a system provided herein also enable optional approval and review workflow on a case-by-case basis.

Embodiments described herein may provide various advantages. For example, it may be possible to address the problem of a paralegal (or other legal team member) having to manually identify custodian representatives to notify based on custodians implicated in a matter/case. Rather than manually search for a custodian representative, representative information may be automatically made available for a user based on a custodian selection by the user, for example through a user interface. Via one or more interfaces, users can select internal and/or external reviewers and approvers before issuing a mandate notice to the representatives. Legal hold information can also be included as dynamic tags with the mandate notice, and the notice sent may be synchronous with real time data-updates, if any, to a legal hold or matter will be reflected, for example. Mandate notices may be sent as immediate notices to representatives or can be scheduled for future issuance. Further, because such an approach is a workflow-driven process, it is auditable at any point of time.

In this way, it is possible to avoid sending individual communications, such as emails, to a custodian's representatives whenever a new matter arises in a company or when the matter closes. Likewise it is possible to avoid manual tracking of such operations, which is error prone and likely to lead to incorrect and/or inconsistent selection of custodian representatives.

In some embodiments, the described system stores and makes representative information readily available to user selections, and further enables (e.g., through a display and/or interface) users to send a notice to representatives automatically during the initial stages of a matter, and a termination notice when a matter is completed or no longer active. The process is tracked, auditable, and analyzable to identify the right metrics at any point in time.

The above advantages and other advantages, and features of the present description will be readily apparent from the following Detailed Description when taken alone or in connection with the accompanying drawings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 schematically shows an exemplary system in which a corpus of documents may be contained in accordance with an embodiment of the present disclosure.

FIG. 2 schematically shows an exemplary enterprise management system in accordance with an embodiment of the present disclosure.

FIG. 3 shows an exemplary legal mandate workflow in accordance with an embodiment of the present disclosure.

FIG. 4 shows a flowchart illustrating a method for managing a legal mandate in accordance with an embodiment of the present disclosure.

### DETAILED DESCRIPTION

During or in anticipation of a litigation, parties to the litigation may be required to preserve and eventually produce documents in their possession that relate to the litigation. Documents to be preserved are known as being subject to a litigation hold. Documents may exist in electronic form in computer systems or electronic storage devices. One element of electronic discovery (e-discovery) involves obtaining a thorough set of relevant documents from those computer systems and electronic storage devices. When there is a large number of documents contained in one or more computer systems, the manual e-discovery process can be very cumbersome, as compliance with a litigation hold requires a thorough search of the computer systems and electronic storage devices. However, at least for reasons of privacy and confidentiality, parties want to avoid producing documents that are not relevant to the litigation. Therefore, a final determination of a document's relevance to the litigation is usually made by a manual review process. The expense of this process is related to the number of documents reviewed.

To reduce the expense of e-discovery, computer software may be used to automatically search for and retrieve relevant documents. Typically, the software will search for emails or documents containing selected keywords or names of individuals related to the litigation. The names and keywords used in the search are identified by the parties or people associated with the case. However, the results of such searches may include many documents that are not relevant to the litigation or may exclude many documents that are relevant to the litigation.

Example systems relate to systems and methods for performing electronic discovery of documents subject to a litigation hold, and particularly to efficiently identifying a set of relevant documents. Electronic files may correspond to various file types, including but not limited to an email, text message, distribution list, spreadsheet, text file, bit map, or graphics file. One of ordinary skill would recognize that other types of electronic files (e.g., electronic documents) may also exist according to embodiments. Electronic documents, as referred to herein, may be accessible by known electronic communications methods and may be stored in a variety of data sources, including but not limited to electronic media, such as Random Access Memory (RAM) or Read Only Memory (ROM), magnetic media, such as tape drives, floppy disks or hard disk drives (HDD), and optical media, such as Compact Disks (CD) or Digital Video Disks (DVD).

To define the parameters and criteria of a legal hold, a legal team may consider the facts of the case and the parties involved in the events leading up to the case. Based on the locations of these documents, a target corpus of documents to be search may be identified. In some cases, it may be necessary to search through a large number of documents in a large storage area to find a few documents containing relevant information. The storage area to be searched may be identified by physical storage devices, logical storage partitions, document security designations, or by any other means known to one of ordinary skill in the art. A large search scope increases the potential for finding relevant documents but may require a prohibitively large search time and expense. The entire corpus of documents may be searched for documents that are relevant to the litigation, and a manual review of every document in the corpus could be a long and laborious process. Effectively filtering or culling the corpus may reduce the quantity of documents that need to be reviewed. Documents not meeting the search criteria may not be reviewed. In embodiments, the corpus of documents may be contained within a single computer or storage device, or the corpus of documents may be spread across multiple servers, client computers, storage devices and other components that may or may not be interconnected. For example, the corpus of documents may be stored in a hosted user environment utilizing distributed storage.

Accordingly, systems and methods for managing legal mandates are provided herein. In one example, a management system comprises at least one processor and memory in communication with the at least one processor. The memory stores instructions executable by the at least one processor to receive a legal mandate, in response to receiving the legal mandate, generate a review board comprising a list of one or more individual reviewers, send the legal mandate to the review board, and receive one or more comments from the one or more individual reviewers with respect to the legal mandate.

FIG. 1 is schematically shows an exemplary system 100 in which a corpus of documents may be contained, according to an embodiment of the present disclosure. The corpus of documents may include electronically-stored information (ESI). Although system 100 is described herein with respect to a limited number of devices and a single network, one of ordinary skill in the art will recognize that a system containing relevant documents may include different numbers of components and other types of components than those shown. In addition, the system components may be standalone or may be interconnected by one or more networks of various types.

System 100 of FIG. 1 is provided as a non-limiting example for explanation purposes. System 100 includes computing devices, such as server 120 and 122, and client computers 102, 104 and 106. System 100 also includes storage devices 110 and 112. The devices in system 100 are interconnected by network 130. Network 130 may be a local area network (LAN), wide area network (WAN), intranet, internet, Wi-Fi, cell phone network, or any other wired or wireless network for communication between computing devices. One of ordinary skill in the art would recognize that there are many possible variations on the number and interconnection of computing and storage devices in which all or part of the corpus of documents could be contained and searched according to embodiments.

Utilizing one or more computing devices, the corpus of documents may be searched for potentially relevant documents. In system 100, a search may be initiated, for example, at client computer 102. The corpus of documents may be isolated to documents stored within client computer 102. Additionally, or alternatively, the corpus may include documents contained within, e.g., storage device 110 and/or server 120. When a search is performed, information about each document or set of documents in the corpus of documents may be obtained. This information is compared to a set of search criteria that has been prepared in response to the legal hold. The search criteria may include several types of information used to identify potentially relevant documents. For example, the names, locations, creation dates, modification dates, other date ranges, etc. of documents satisfying the search criteria may be returned in the search results. The actual documents may also be returned, or links may be provided to individual documents. Other sets of search results are possible.

FIG. 2 schematically shows an exemplary enterprise management system 200 according to an embodiment of the present disclosure. The system includes a plurality of software routines or modules 204 included on a computing device 202, and in one example, may be an electronic discovery management server. Computing device 202 may interface with system 100 described above in which a corpus of documents may be contained. Further, computing device 202 may interface with one or more 3rd party or other applications 222. As shown, network 130 may communicatively couple system 100 to enterprise management system 200 as well as their subcomponents.

As shown, computing device 202 includes a processor 201 and memory 203. It will be appreciated, however, that computing device 202 may include two or more processers. Memory 203 comprises a storage device 205, which together may form a memory/storage hierarchy comprising, for example, one or more of optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. The memory hierarchy may include volatile, nonvolatile, dynamic, static, read/write, read-only, random-access, sequential-access, location-addressable, file-addressable, and/or content-addressable devices. Memory 203 may comprise two or more storage devices 205, however. Processor 201 may be configured to access non-transitory data stored on memory 203 and/or storage device 205 and execute instructions stored thereon. In some embodiments, the plurality of modules 204 may be stored on storage device 205, for example.

In some examples, computing device 202 may be included in system 100, behind a firewall, for example, so that modules 204 may be accessed by one or more client devices within system 100. As another example, computing device 202 may be a server residing on the internet so that the plurality of modules 204 is stored in a cloud-based environment. One or more client devices included in system 100 may be configured to access one or more modules in the plurality of modules 204. Further, in some examples, one or more modules in the plurality of modules may be included on one or more client devices in system 100.

By way of example, the plurality of modules 204 includes a visualization module 206 for displaying information, examples of which being described herein, a project manager 208, a legal hold manager 210 including an interview manager 211, a custodian manager 212, a data mapping module 214 which stores information in a data map database 216, a predictive module 218, ESI collection and processing module 213, ESI analyzer 217, ESI production module 219, and review and processing manager 224. Further, enterprise management system 200 may be configured to interface with various third party or other applications 222 and/or with internal and legacy systems 221, e.g., for integration with active directory (AD) and/or other current information technology (IT) investments, matter management systems, software by RECOMMIND, etc. Finally, enterprise management system may interface with an human resources (HR) database 226. As described in further detail below, HR database 226 may store one or more parameters each with a plurality of custodians such that actions described herein may be taken in response to the one or more parameters and changes thereto. It should be understood that the plurality of modules 204 may include additional functionality associated with the enterprise management system, examples of which are described below. Further, it will be appreciated that modules in the plurality of modules 204 other than data mapping module 214 and predictive module 218 may be communicatively coupled to one or more storage devices as well.

Enterprise management system 200 may perform a variety of functions relating to managing workflows for various e-discovery applications and tools, and provides a common platform to enable different e-discovery applications to work as a unit. Such a common platform can also integrate with information governance tools, such as data management, human resource (HR) systems, archiving applications, and other third party applications (e.g., via third party or other applications 222) for a more streamlined response to e-discovery requests. As described in further detail below, the enterprise management system may use information gathered by an e-discovery hub to facilitate the approaches described herein.

Visualization module 206 may be configured to facilitate visualization of the processes, workflows, and data described herein. To accomplish this visualization, the visualization module may present visual information (e.g., text, graphics including images and video, etc.) in a suitable graphical user interface (GUI). “Dashboard” as used herein may refer to such a GUI used to present visual information and facilitate visualization.

In some examples, visualization module 206 may facilitate intuitive navigation, and real-time, top-down/bottom-up views, of organizational structures and hierarchies, business units, systems such as data sources, and matters, cases, and records. For example, a multidimensional representation of an organizational structure may be presented based on configurable criteria. Litigation profiles may also be presented, and, in some views, data sources may be filtered according to litigation risk, for example to address 26(f) conference negotiation and 30(b)(6) deposition preparations. An executive management console may provide creation and viewing of customized data lists in real-time.

Exemplary dashboards that may be presented by visualization module 206 include a navigation dashboard that may provide an intuitive, user-friendly visual overview of data maps, workflows, and subcomponents. A more specific data map dashboard may allow users to view all changes, trends, and relationships between systems (e.g., data sources) by compliance regulation or system status through a powerful, bird's-eye view reporting function. An EDRM dashboard may present within and among matters, information, custodians, projects, schedules, and EDRM phases. Finally, a discovery landing page or dashboard may help ensure deadlines are met through at-a-glance workflow visibility into custodians, deliverables, issues, notes, and ETA both at overall project levels and at workflow stage levels across multiple matters. Exception reports may be presented, indicating visibility into problem areas that require prompt attention. Generally, the dashboards and GUIs described herein may be customized according to user input. Further, dashboards and GUIs of the present disclosure may implement multi-language support.

Returning to FIG. 2, project manager 208 may be configured to define e-discovery processes and workflows, and manage these processes. The project manager module may facilitate management of components of an automated e-discovery system, including template management by facilitating customization and/or creation of templates that reduce work, minimize errors, and standardize the information collected about electronically stored information. In particular, preformatted customizable templates may be used to create work orders as part of quickly designing e-discovery projects. Projects and work orders may be reused by dragging and dropping customizable specifications. Configurable questionnaires and specification sheets may also be created, for example. The project manager module may further facilitate establishment of preferred project settings that may be provided to a user to assist in project creation.

Project manager 208 may provide project checklists for different states of a given project—for example, at the end of the project. A checklist may ensure that an assigned task is completed according to the checklist specified by the project manager. The project manager may further track, issue, and communicate resolution steps to team members with an advanced messaging system to meet deadlines. In one example, real-time notifications may be received through an SMTP email integration that sends notifications to project managers when events require attention or follow-up.

Project manager 208 may also provide oversight over internal and external service providers' performance. For example, a vendor input portal may facilitate evaluation of vendor service offerings and prices. The vendors may be particularly evaluated based on configurable units of measure that provide an “apples-to-apples” comparison of cost, turnaround times, and ratings. Moreover, the project manager may maintain active service records for all vendors and third party service providers, containing information on the services provided and associated costs. When a project is created, a user can select from among those vendors who perform the service, comparing costs and performance metrics across the list of available vendors.

Project manager 208 may aid in cost/budget management, projection, and estimation. Actual budgets may be forecasted and spending tracked, including variances at the resource level. Template creation described above may include the creation of budget templates for all tasks, matters, and projects with auto-populated cost estimates. Each budget can be easily configured to reflect standard as well as one-of-a-kind costs. Further, projects may be priced out based on accurate data, while cost variance alerts may be provided when cost overruns occur. Flexible resource planning and management capabilities, including multiple units of measure, may help to control costs and avoid project surprises. Cost and budget tracking in this way may support a burdensome cost and cost-shifting argument in court.

Project manager 208 may also assist in process automation to provide a standardized process which facilitates building an evergreen data map. Data source information management may be facilitated by keeping usage and relationship history between data sources and custodians up to date and evergreen, enabling quick deployment of legal holds. More particularly, data source information management may provide details regarding employee ownership of all electronic data sources in an organization in addition to the kinds of data that are accessible in the system. In this way, collections from key custodians and non-custodial data sources (NCDS) may be prioritized, accelerating delivery of key information critical for effective early case assessment and resource allocation. The project manager may facilitate viewing and reporting on discovery activity at custodian and data source level, including activity with electronic documents and records management (EDRM) tools, highlighting prior collection, processing, review and production efforts.

Project manager 208 may further implement version control, change management, and automatically generated audit trails. In particular, the project manager may facilitate history management by recording all of a team's discovery efforts, reducing risk exposure and eliminating wasteful re-collections. Reports delivered by the project manager may deliver insight into data sources and custodian activity past and present.

In combination with other modules of the plurality of modules 204, including but not limited to visualization module 206, project manager 208 may allow access to third-party tools (e.g., via third party or other applications 222) and resource teams' project progress through a single platform. In this way, discovery trends and phase details may be analyzed. Advanced reporting and dashboards described herein may deliver critical information. It will be appreciated, however, that project manager 208 may facilitate additional functions outside the realm of ESI, such as paper evidence collections and custodian depositions.

In some examples, project manager 208 may maintain activity logs that track user and system activity to aid, for example, in trial preparation, defensibility, and audits. In some embodiments, creation and/or saving of the activity logs may be automatic.

Effective e-discovery management is greatly dependent on consistent, repeatable processes and workflows. Workflows specifically define the interplay among people, processes, and technology as e-discovery projects move from start to finish. This interplay is extremely important in a process that involves a variety of stakeholders (legal, IT, records management, etc.), a bevy of minute tasks, and multiple departments. Project manager 208 may provide an end result that is a proactive, well-defined process with clearly defined objectives, timelines, and assignments that serves as a framework for establishing goals, setting expectations, and monitoring performance at various levels during the matter, thus assuring timely completion of each stage of e-discovery in a defensible manner.

Legal hold manager 210 may be configured to automate and manage a legal hold process. As part of a legal hold process, the legal hold manager may execute a multitude of actions, including but not limited to sending and managing notifications that succinctly convey the actions required for a legal hold or data map request, for example. In some scenarios, a plurality of notifications may be sent by the legal hold manager via a common platform, making it easier to understand the notifications and comply with the required actions. Thus may assist in complying with Federal Rules of Civil Procedure (FRCP) requirements and due diligence required in litigation, for example, and help automatically prevent spoliation of ESI.

Interview manager 211, shown as being integrated within legal hold manager 210, may be configured to create, manage and automate interviews and surveys for purposes including but not limited to depositions, 26f preparation, data mapping projects, custodian identification, data preservation or collection, and other processes where critical information is needed to drive projects forward.

In some examples, interviews may be automatically created by interview manager 211 in response to creation of a legal hold. The interviews may comprise questionnaires that may be customized, and in some embodiments, autopopulated with custodian and other user data via integration with HR systems (e.g., HR database 226), reducing manual work. Templates, described above, may be used to repeat similar types of interviews, and interviews may be created based on various answer types pulled from a questionnaire library.

Users may interact with interviews at various stages of their evolution in different ways. Interview creators, for example, may impose deadlines by which answers and other information is to be received, schedule interviews, and create notifications, reminders, and escalation notices if sufficient compliance is not achieved. In particular, unresponsive custodians may be escalated to their supervisors. Reminders and escalations may be suspended and resumed at an interview and participant level, however. Information gathered by an interview or survey may trigger other actions in enterprise management system 200, including but not limited to including in-person interviews, legal hold notifications, or data map refresh requests. Further, such information may be tabulated relational database or other suitable data structure for flexible analysis and reuse. A dashboard specific to interviews, presented via visualization module 206 for example, may be provided to succinctly summarize the interview status and progress, and enable escalation if required. The dashboard may indicate all custodians whose compliance has yet to be fulfilled, for example. It will be appreciated that interviews and surveys may be distributed and conducted in various suitable manners—e.g., interviews may be distributed via SMTP or other email integration via network 130 and conducted electronically, or may be conducted over the phone or in-person.

Interview manager 211 may facilitate a thorough custodian interaction with an interview and related tasks. For example, custodians may ask questions and receive answers regarding obligations and compliance related to an interview. Custodian interaction may be mandated, however, in which case the interview manager may require a custodian to acknowledge an interview (or legal hold, data map request, etc.), confirm that they understood it, and facilitate communication with the legal team if clarification is needed. In some embodiments, custodians may have the ability to add and associate data sources with a legal hold.

Custodian acknowledgment may be handled in a variety of manners. For example, interview manager 211 may implement proxy acknowledgment in which acknowledgments may be captured by proxy (e.g., on behalf of high-profile custodians) through a third party. Proxy acknowledgment may comprise sending a separate notice to implicated high-profile custodians. Self-acknowledgment may also be carried out, which may facilitate compliance with European Union (EU) privacy laws. Moreover, custodians may be able to self-certify the data sources and data types for which they are responsible, and also upload relevant documents for a legal hold or data mapping request when appropriate.

Legal hold manager 210 may execute a variety of actions based on participant responses to interviews and surveys issued by interview manager 211. Such actions may assist with custodian release, preservation, and collection performed by enterprise management system 200.

In some embodiments, hold notifications (and other notifications) issued by legal hold manager 210 may be updated based on changes to data held in HR database 226. For example, HR database 226 may store and associate a plurality of parameters with a plurality of custodians. Issuance of hold notifications may thus be controlled in response to changes to such parameters, including but not limited to change in employment status, termination, paid leave, change in job title, change in job responsibilities, etc. Issuance of hold notifications may be controlled via user input or by other aspects of enterprise management system 200, however. Moreover, publication status, used herein to refer to whether a custodian is notified of a legal hold (or other action) in which they are implicated, may be updated based on changes to the aforementioned HR database parameters.

In some embodiments, issuance of legal hold notifications, release notifications (e.g., indicating that a custodian is no longer subject to a legal hold), and other notifications to a given custodian may be controlled based on whether that custodian has associated therewith a publication parameter indicating that the custodian has a non-publication or non-published status—in other words, that the custodian is not to be notified of the legal hold. In this way, legal hold issuance or release may be handled “silently”. For example, the legal hold manager may involve custodians in a hold from issue until release, without sending any notification (e.g., issue, re-issue, escalation and release notices). Under such conditions, the custodians may remain involved in the hold, and tracked, monitored, etc., without receiving notifications. Silent handling in this way may be a function of one or more parameters found in HR database 226 described above. In other examples, a non-publication status may be assigned to a custodian or other individual if it is desired to avoid sending repeated notifications to that custodian/individual. Assignment of the non-publication status may also be useful in instances in which the maintenance of data associated with a custodian is desired even after the custodian is released from a hold, as sending a release notification may cause the custodian to delete the data. In this example, the custodian remains under the impression that the hold still applies.

As an example use case, a legal hold for a legal matter may implicate a group of custodians—e.g., five custodians participating in the legal hold. A subset of the custodians may have a published (e.g., publication status allowing issuance of notifications) status whereas the other custodians may have an unpublished (e.g., non-publication preventing issuance of notifications) status. If a first, second, third, fourth, and fifth custodian are participating in a legal hold associated with a matter involving an investigation of the fifth custodian, then the first, second, third, and fourth custodians may be assigned a published status and may receive certain notifications associated with the legal hold. However, the fifth custodian may be assigned an unpublished status and may not receive certain notification associated with the legal hold. However, if those same five custodians are concurrently associated with another legal matter, they may each be designated as a published custodian with respect to that matter and all will receive notifications via the system.

It will be appreciated that legal hold notifications, and other notifications including but not limited to release, reminder, and escalation notifications, may be issued in various suitable manners. For example, such notifications may be issued through email. The emails may enable one click (or other suitable user interaction) navigation from the notification to a variety of features. In some embodiments, email addresses stored in a custodian directory in custodian manager 212 may be used as a basis on which to issue notifications. Further, in the course of constructing a legal hold, legal hold manager 210 in some embodiments may suggest potentially relevant custodians to one or more custodians already selected for the legal hold, which may accelerate the notification and collection processes. Potentially relevant custodians may be derived from the custodian directory in the custodian manager, for example.

Legal hold manager 210 may include other features. For example, the legal hold manager may present a GUI by which escalations, notification resends, and hold releases may be issued with one click (or other suitable engagement with the GUI) from a central location. The GUI may also track custodian information and communication. In some embodiments, the GUI may be web-based and matter-centric. Moreover, this and other information (e.g., legal hold and other task assignment, escalations, reminders, releases, etc.) may be tracked over time to form historical custodian and matter data that may be searched according to various parameters including data ranges. For example, all legal hold escalations issued between a first date and a second date may be discovered in this way.

Legal hold manager 210 may also interface with project manager 208 to utilize templates to facilitate rapid legal hold creation, which may increase consistency of the legal hold process. In some examples, some templates may be marked as “private”. Private templates may restrict access to sensitive information for the purposes of privacy and security. Whether or not hold notifications are derived from templates, the hold notifications may be customized based on user input, however. Moreover, the legal hold manager may implement dynamic tags which may be used to propagate real-time information throughout hold notifications.

Legal hold manager 210 may be further configured to preserve data, for example in order to comply with litigation. The legal hold manager may preserve written communication (e.g., email) and data hold requests, for example. The legal hold manager may also preserve data in two manners: at a data source and via collection. In the first manner, data may be preserved at the source on which it resides by preventing its deletion or medication at the source. In the second manner, which may be performed alternatively or additionally to the first manner, data is preserved by copying the data from its data source to a storage medium (e.g., 216) where the data cannot be deleted or otherwise modified.

Returning to FIG. 2, legal hold manager 210, along with other modules of the plurality of modules 204 in enterprise management system 200, may implement an open architecture, permitting customization and integration with other data preservation and storage technologies. For example, integration with third-party electronic discovery reference model (EDRM) tools such as Symantec Enterprise Vault and Discovery Accelerator, Recommind InSite, StoredlQ, Informatica and Clearwell, as well as other existing enterprise applications, may be possible. Integration in this way may bridge the gap between legal departments and IT, and may simplify the process for a legal department to pass instructions to IT to safely lock down data so custodians can continue mission-critical job tasks.

Legal hold manager 210 may implement other functionalities. For example, the legal hold manager may facilitate robust tracking and auditing via activity logs and chain-of-custody reports. The legal hold manager may also form lists of custodians and data sources implicated in a hold. As described above, the legal hold manager, in combination with visualization module 206, may collect and present all information relating to a legal hold via a single dashboard, which may help integrate communication between custodians and legal teams. Moreover, the legal hold manager may facilitate the searching and linking of two or more holds (or matters) to one another and to custodians and data sources. In this way, legal teams may have the capability to find all data related to a particular matter or matter type, enabling them to leverage available information, and reducing spoliation risk.

Other features may result from the combination of legal hold manager 210 with visualization module 206. For example, user may view the number of active and inactive legal holds for each data source and custodian via intuitive graphical display. Users may drill down to view additional details about the active legal holds and hold histories. Further, user may monitor compliance data map, interview, and legal hold requests to understand levels and completion and areas where escalation may be needed.

Continuing with FIG. 2, custodian manager 212 may be configured to facilitate custodian management. The custodian manager may allow access to all custodian and data steward information from a centralized location. As described above, custodian manager 212 may include a custodian directory comprising a plurality of custodian profiles relating to custodians, wherein each custodian profile includes one or more parameters associated with a given custodian. The one or more parameters may include a publication parameter (e.g., status identifier) identifying whether the custodian should be notified of a legal hold (or other event) in which they are implicated. Specifically, a non-publication parameter associated with a given custodian indicates that the custodian should receive legal hold (or other) notifications, and is configured to enable managing and tracking of the custodian in the directory without notifying the custodian.

The custodian directory may comprise a plurality of tables comprising personalized data relating to the custodians, including name, title, notification dates, e-mail address, information relating to storage locations in network 130 associated with the custodians, etc. Further, changes to these and other parameters may be detected; for example, change in employment status, termination, paid leave, job title, job responsibilities, etc. may be used to drive custodian interaction.

In some embodiments, the custodian directory may be further configured to interface with HR database 226 and update publication parameters based on periodic accesses to the HR database responsive to changes to the one or more custodian parameters described above. In other embodiments, updating may be automatic upon receiving updates from the HR database. Such a configuration may obviate the problem of IT administrators having to periodically and manually update custodian information.

In some examples, changes that occur to custodian profiles in the custodian directory may be recorded over time such that the custodian profiles comprise historic information relating to the custodians, including historic information regarding previous publication and non-publication statuses.

In some embodiments, one or more custodian representatives may be associated with one or more custodian profiles in the custodian directory. Notifications, data, and other information implicating a custodian may be sent to his or her representative(s) by retrieving the representative(s) for that custodian by accessing the custodian directory. As described in further detail below, such mediation may particularly be used to issue legal mandates to custodian representatives (or other intermediaries) prior to being issued to custodians themselves. Yet other information may be included in the custodian directory—for example, potential individual reviewers that may be assigned to reviews of legal mandates may be stored in the custodian directory, or in other embodiments, another similar directory of persons. A given custodian representative may represent one or more custodians, and may be a member of a works council, labor union, or other organization, for example.

Returning to FIG. 2, data mapping module 214 may be configured to perform identification of ESI as it resides across system 100 and to create a data map stored in data map database 216. Developing a data map that can grow and change with the system may include capturing details about how potentially relevant ESI is used, stored, preserved, and accessed for a specific matter or, more commonly, across an entire litigation portfolio. Rich and complete data capture may be provided via integration with third party or other applications 222 including HR and asset management systems, IT infrastructure and EDRM tool integrations, and other e-discovery, legal hold, and litigation management solutions. In some embodiments, building and maintenance of the data map may be user-initiated. For example, periodic reminders may be issued to prompt a user to initiate mapping of data. Data mapping according to a predetermined schedule or in response to data updates in enterprise management system 200 are contemplated as well, however.

Data mapping helps an organization build and maintain an evergreen data map, mirroring a company or other institution's information base as it evolves. Data mapping module 214 may include various visualization features, e.g., coupled with visualization module 206, to provide a rich visualization and cross-functional collaboration capabilities to facilitate a structured inventory for identifying, collecting and producing relevant ESI, providing an advantage in meet-and-confer preparations. In particular, visualization features resulting from coupling the data mapping module with the visualization module may include visibility into and control over identified data sources and information, including real-time insight into data mapping.

By building a data map, institutions and organizational departments, such as IT and inside counsel, may have increased leverage with which to negotiate favorable scopes of discovery and have a more realistic understanding of how burdensome it will be to comply with discovery requests. Moreover, smarter litigation response to e-discovery and regulatory compliance requests and company internal investigations may be facilitated.

Predictive module 218 may be configured to employ predictive technologies in order to assist users in the prioritization of documents for review, among other purposes (e.g., anticipate e-Discovery requests). Because of the sheer amount of potentially relevant ESI and Big Data involved in a typical e-discovery request, it is often prohibitively difficult for humans to manually review each document for relevancy. Human error in judging the relevance of documents further compounds the difficulty of document review. As such, the predictive module may potentially reduce the cost of review. In some embodiments, the predictive module may employ machine learning to prioritize documents for review.

ESI collection/processing module 213 may be configured to facilitate collection of ESI in a typical EDRM process. For example, data distributed across and residing on various devices within network 100 may be collected. Further, metadata associated with the data may be collected.

ESI analyzer module 217 may be configured to facilitate analysis of ESI in a typical EDRM process. For example, the analyzer module may assist with determining the relevance of collected ESI, establish hierarchies regarding the data (e.g., within a department), and analyze the data in view of litigation history. The analyzer module may further review data sources that store ESI and particularly whether data stored thereon can be modified or destroyed. Finally, the analyzer module may determine potential custodian behavior including potential compliance with tasks (e.g., legal hold, data map request, etc.).

ESI production module 219 may be configured to facilitate production of ESI and other data in a typical EDRM process. For example, the production module may facilitate production in compliance with FRCP rules including rule 26(f), analyze data formats (e.g., whether they are native, near-native, images, paper, etc.), analyze production requirements (e.g., file formats, whether text should be searchable), and prepare and copy data to suitable media (e.g., optical media such as CD, DVD, HD-DVD, Blu-Ray Disc, etc.; magnetic memory such as hard-disk drive, floppy-disk drive, tape drive, MRAM, etc., among others).

Internal/legacy systems 221 may include other modules and/or systems internal to departments or organizations, and/or legacy systems. For example, the internal/legacy systems may comprise computing systems, data sources, and/or operating systems or other software. In this way, hardware and software that may otherwise be outdated and/or incompatible may be integrated with enterprise management system 200 for involvement with the approaches described herein.

As described above, enterprise management system 200 may interface with third party or other applications 222. The third party or other applications may include IT systems, content management applications, and EDRM tools, for example. For example, the system may perform integrations through web services, and/or data transfer (e.g., of documents, spreadsheets, media files, etc.) to ensure that users are always alerted when key changes occur in other systems. In some examples, the enterprise management system may be seamlessly integrated with HR systems, asset management, matter management, single sign-on, Lightweight Discovery Access Protocol (LDAP), and other critical IT systems. These connectors capture and translate data, dispatch work to other applications, correlate activities, and summarize results so e-discovery teams can efficiently complete projects and avoid ambiguity. In addition to centralizing access to critical organizational data, these connectors facilitate inspecting and searching files and metadata to help evaluate collection efforts and locate responsive information. These data source connectors play a critical role in later stages of the discovery process. This configuration may provide an extensible, flexible framework and robust software adapters that enable organizations to leverage existing IT investments, gain visibility into other EDRM tools, and collect ESI from diverse data sources

Review and processing manager 224 may be configured to facilitate the processing and review steps of a typical EDRM process in a combined module. For example, the review and processing manager may determine, on an item-level, what data is present in a volume of collected data (e.g., a collection of ESI relating to one or more matters stored in database 216). Metadata associated with the data may be recorded prior to processing, and data deemed irrelevant to the task at hand may be discarded. Data may also be extracted and/or decompressed by the review and processing manager.

The review and processing manager may facilitate other functions. For example, the review and processing manager may implement concept-based searching of data and not just keyword searching. Pattern recognition may also be utilized to reduce the burden of review, and tools, within the plurality of modules 204 and/or within third party or other applications 222, may be recommended based on analysis of the data.

As shown and described, enterprise management system 200 may provide a streamlined, fully defensible integrated system that delivers cost savings and complete visibility at each stage of a typical EDRM process, while significantly reducing the risk of process failures and data spoliation that may arise from information transfers between disparate steps using a non-integrated approach.

Turning now to FIG. 3, an exemplary legal mandate workflow 300 is shown. As described in further detail below, one or more of the plurality of modules 204 of enterprise management system 200 may be utilized to execute workflow 300. The workflow may streamline the legal mandate process and reduce costs associated with manual review, for example.

The organizational legal department prepares a legal mandate when in litigation or when litigation is anticipated. In some examples, the legal mandate may be a legal hold for preserving ESI, for example. As indicated at step 1 in FIG. 3, the mandate is sent, for example via enterprise management system 200, to a review panel involving legal personnel. The legal mandate review panel reviews the mandate, for example via a GUI (or other interface) presented by visualization module 206 of enterprise management system 200, and at step 2, responds back to the legal department with their review comments, again optionally through a GUI presented by the visualization module. In some examples, the review comments may be consolidated to form consolidated comments, which may include reducing redundancy and/or categorizing feedback, for example. At step 3, the reviewed mandate is then issued to the custodian representatives based on a custodian directory for the given litigation matter. In some examples, as indicated at step 4, the custodian representatives may send a response to the legal department in case of any concerns, again via a GUI or other interface presented by the visualization module. As shown in step 5, the legal mandate may be issued to the custodian or data steward. However, as indicated at step 6, when the mandate is no longer needed, e.g., if the case is no longer active, a termination notice may be issued to the custodian representatives. In some examples, enterprise management system 200 of FIG. 2 may receive a request to terminate the legal mandate, and in response may issue the termination notice to selected email addresses, which may be retrieved from HR database 226, for example. Recipients associated with the selected email addresses, and who receive the termination notice, may then forward the termination notice to selected custodian representatives.

As described above, one or more steps in workflow 300 shown in FIG. 3 may be at least partially automated by enterprise management system 200 of FIG. 2. Further, in some examples, notifications, status of the legal mandate, action items associated with the mandate, etc. may be displayed in a centralized interface (e.g., GUI) or dashboard, presented via visualization module 206, for example. In some scenarios, an entity associated with performing one or more tasks in the workflow may receive notifications indicating that action is required in processing the mandate. For example, members of the legal mandate review panel may receive a notification to review a mandate in response to the legal department sending a legal mandate for review via the enterprise management system.

Once workflow 300 of FIG. 3 is completed, then legal hold notices may be sent to the identified custodians (for which the legal mandate has been reviewed by their representative). The legal hold notices, tracking, data gathering, etc., may then proceed, as described herein.

FIG. 4 shows a flowchart illustrating a method 400 for managing a legal mandate. Method 400 may be executed on enterprise management system 200 of FIG. 2 via one or more of the plurality of modules 204, for example. Specifically, the operation of FIG. 4 illustrates how a legal mandate may be created, tracked, communicated, and managed. To create the legal mandate, a user (e.g., creator) first creates a matter at 402, which may be for a particular lawsuit, case, etc., by interfacing with a user interface which may be presented by visualization module 206 of enterprise management system 200, for example. Although not repeated for each step herein, the enterprise management system may receive user input and generates displays and/or data in response thereto as indicated. Once the system creates the matter, the user may scope the custodians at 404, again through a user interface of the system. The scoping of the custodians may be performed in various ways, including auto-identification via the enterprise management system, which may utilize smart scoping, as described below. Additionally, or alternatively, the system may generate potential lists of custodians which are selected, via a user interface, by the user for use with the created matter. Next, the user, through an interface of the system, may create a legal mandate at 406 and select reviewers for the legal mandate at 408. The user may select reviewers from a list generated and/or auto-populated by the system based on HR data (e.g., from HR database 226) or other parameters. Further, the user may select, through an interface of the system, at least two CUSs to be associated with the legal mandate at 410.

Once the user has created and selected the above information via the system, the user may provide a request for submission of the legal mandate to the selected executors for approval at 412, along with submission of a copy of the legal mandate to the selected reviewers. In response thereto, the system may generate and send such submissions, such as via e-mail messages generated by the system.

Continuing with FIG. 4, the system facilitates a review of the generated mandate first by the reviewers, and once edited, sends the reviewed mandate to the executor for issuance. Specifically, the system sends the generated mandate to the selected reviewers, as noted above, and receives the reviewers input, such as through an interface or via electronic communication such as e-mail. If the reviewers provide comments to the mandate (YES at 414), the system identifies this fact, and in response thereto generates and sends a notification to the user that created the legal mandate at 416. That user then interacts with the system to indicate whether the mandate will be modified and/or resubmitted, such as with changes made by the user in response to the comments. The system again tracks updates to the mandate and if it receives an input that the mandate has been updated and is to be resubmitted (YES at 418), edits legal mandate information at 420 and again communicates the updated mandate to the executors and reviewers at 412, as stated previously. If the system receives an input indicating that the mandate will not be resubmitted (NO at 418), the system deletes the legal mandate at 422 and terminates the mandate process.

Once there are no further comments from the reviewers received by the system (NO at 414), for example via an input from each of the selected reviewers that no further changes are needed, the system sends the legal mandate to the executors for issuance. If the executors provide an input (e.g., approval) to the system confirming that the mandate should be issued (YES at 424), the system then issues the mandate to the representatives of the identified custodians. As such, the representatives receive the mandate at 426. If the executors do not provide an input to the system confirming that the mandate should be issued (NO at 424), the method returns to 416. The system may track the issuance and retain logs indicating that the mandate has been issued.

Only after the mandate has been issued and communicated to the representatives, and the process documented and completed, may users then provide inputs to the system to generate legal hold notices that the system sends to the custodians, along with the various other features related thereto, as described herein. In other words, the system will not send legal hold notices to custodians until the legal mandate process described above with regard to FIG. 4 is complete, even if requested by a user to do so, at least in one example embodiment.

Note that the example systems and programs described herein may represent various acts, operations, or functions, each of which may be performed in the sequence described, in parallel, or in some cases omitted. Likewise, the order of processing is not necessarily required to achieve the features and advantages of the example embodiments described herein, but is provided for ease of illustration and description. One or more of the described program actions, operations, and/or functions may represent code to be programmed into a non-transitory computer readable storage medium in enterprise management system 200.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A management system, comprising:
at least one processor;
memory in communication with the at least one processor, the memory storing instructions executable by the at least one processor to:
receive a legal mandate;
in response to receiving the legal mandate, generate a review board comprising a list of one or more individual reviewers;
send the legal mandate to the review board; and
receive one or more comments from the one or more individual reviewers with respect to the legal mandate.

2. The management system of claim 1, wherein the instructions are further executable to, after receiving the one or more comments, issuing the legal mandate to one or more custodian representatives implicated by the legal mandate.

3. The management system of claim 1, wherein the list of individual reviewers is received from a human resources database communicatively coupled to the management system.

4. The management system of claim 1, wherein the list of individual reviewers is received from a list of persons designated as possible review board members, the list of persons stored in the management system.

5. The management system of claim 1, wherein the instructions are further executable to generate one or more graphical user interfaces to facilitate review of the legal mandate by the review board.

6. The management system of claim 1, wherein the instructions are further executable to:
consolidate the one or more comments from the one or more individual reviewers to form consolidated comments;
store the consolidated comments in the memory; and
send the consolidated comments to designated personnel in a legal department.

7. The management system of claim 1, wherein the instructions are further executable to:
send the received one or more comments to a creator of the legal mandate; and
receive an updated legal mandate from the creator.

8. The management system of claim 7, wherein the steps of sending the received one or more comments to the creator of the legal mandate, and receiving the updated legal mandate from the creator are repeated until no further comments are received from all of the one or more individual reviewers.

9. The management system of claim 7, wherein the steps of sending the received one or more comments to the creator of the legal mandate, and receiving the updated legal mandate from the creator are repeated until no further approvals are received from all of the one or more individual reviewers.

10. The management system of claim 1, wherein the instructions are further executable to:
issue a reviewed legal mandate to an executor;
issue the reviewed legal mandate to selected custodian representatives responsive to executor input; and
save and track issuance of the reviewed legal mandate to the executor and to the selected custodian representatives.

11. The management system of claim 10, wherein the instructions are further executable to:
receive a request to terminate the legal mandate;
in response to receiving the request to terminate the legal mandate, issue a termination notice to selected email addresses, the termination notice to be forwarded to selected custodian representatives by recipients associated with the selected email addresses.

12. The management system of claim 10, wherein the instructions are further executable to only after issuance of the legal mandate, issue one or more hold notices to selected custodians represented by the selected custodian representatives, the one or more hold notices related to a matter identified by the legal mandate.

13. The management system of claim 1, wherein the instructions are further executable to:
provide an interface to one or more executors of the legal mandate, the interface configured to receive one or more responses from the one or more executors; and
send the received one or more responses to a legal department.

14. A method, comprising:
creating a legal mandate based on first user input;
selecting one or more reviewers of the legal mandate based on second user input;
receiving one or more comments regarding the legal mandate from the one or more reviewers;
editing the legal mandate based on the received one or more comments and third user input; and
issuing the legal mandate to one or more custodian representatives representing one or more custodians implicated by the legal mandate.

15. The method of claim 14, wherein the legal mandate is issued to the one or more custodian representatives if input comprising approval is received from an executor of the legal mandate.

16. The method of claim 14, wherein the legal mandate is a hold on electronically-stored information.

17. The method of claim 14, further comprising, prior to creating the legal mandate, creating a matter and scoping one or more custodians associated with the matter based on fourth user input.

18. The method of claim 14, further comprising, after issuing the legal mandate to the one or more custodian representatives, issuing the legal mandate to the one or more custodians, the legal mandate being a legal hold.

19. A management system, comprising:
at least one processor;
memory in communication with the at least one processor, the memory storing instructions executable by the at least one processor to:
generate a user interface display for receiving one or more inputs relating to a legal mandate;
receive the one or more inputs via the user interface display to thereby generate the legal mandate;
in response to receiving the one or more user inputs, generate a review board comprising a list of individual reviewers for reviewing the legal mandate, the list of individual reviewers received from a human resource database in communication with the management system;
send the legal mandate to the review board;
receive one or more comments from one or more individual reviewers regarding the legal mandate;
in response to receiving the one or more comments from the one or more individual reviewers, issue the legal mandate to one or more custodian representatives;
receive one or more comments from the one or more custodian representatives; and
in response to receiving the one or more comments from the one or more custodian representatives, issue the legal mandate to one or more custodians implicated by the legal mandate.

20. The management system of claim 19, wherein the one or more custodian representatives and the one or more custodians are derived from the human resource database, the legal mandate issued to the one or more custodians via respective email addresses derived from the human resource database.
